(19) United States
(12) Patent Application Publication
(10) Pub. No.: US 2015/0272107 A1
(43) Pub. Date: Oct. 1, 2015

(54) Trap Setting Device And Method Of Use

(71) Applicants: Noel Henry, Marionville, MO (US); James L. Andrus, Crane, MO (US)

(72) Inventors: Noel Henry, Marionville, MO (US); James L. Andrus, Crane, MO (US)

(21) Appl. No.: 14/676,063

(22) Filed: Apr. 1, 2015

Related U.S. Application Data
(60) Provisional application No. 61/973,666, filed on Apr. 1, 2014.

(51) Int. Cl. A01M 23/24; B25B 27/30; A01M 31/00

(52) U.S. Cl. CPC A01M 23/245; A01M 31/00; B25B 27/30

(57) ABSTRACT

A device for setting a trap for a fur-bearing animal is described. The device provides leverage for a hunter to set and release a trap without exerting substantial force on the trap. A method for using the device to set and release traps is also disclosed.

### CROSS REFERENCE TO RELATED APPLICATIONS

This continuation application claims priority of provisional U.S. Patent Application No. 61/973,666 filed on Apr. 1, 2014, which is incorporated herein by reference.

### BACKGROUND

The trap setting device and method are in the field of devices for trapping animals. More specifically, the trap setting device and method are in the field of devices to assist in the arming of fur-bearing animal traps.

Arming and setting a trap for animals requires substantial physical hand strength. The environment in which a hunter typically has to set a trap (snow, muddy ground, rough terrain, etc.) creates difficulty and safety issues. The devices themselves are dangerous and the process of setting the traps by hand creates the potential for falls, accidental trap activation, injury to a hunter's hands, or an inability to arm and set the trap. The trap setting device described herein gives a hunter the leverage to pull the trap spring down to set the trap by hand, with minimal effort and safer operation. It also allows the hunter to safely release the trap spring as well, which is another point of potential injury.

Other devices for setting similar traps have to be set on the ground and a user has to use body strength and use their feet to apply pressure to the device and the trap in order to set it. Since the ground may be rough or muddy, and the device may be slick due to rain or snow, a trap setting device that has to operate on the ground and requires a lot of physical strength, is extremely difficult and dangerous.

### SUMMARY OF THE INVENTION

In embodiments, the trap setting device comprises a base member for receiving and holding a trap, the base member having a first end that is bent at a right angle to the remainder of the base member, a top bar, and a connector plate having an upper portion and an angled lower portion. The first end of the base member is fixedly attached to the angled lower portion of the connector plate, and a first end of the top bar is pivotally attached to the upper portion of the connector plate such that a second end of the top bar pivots toward a second end of the base member.

A method for using the trap setting device comprises the steps of pivoting the top bar to an open position, placing a trap on the base member with the spring disposed away from the base member, pivoting the top bar to a closed position to twist the spring, engaging the trigger assembly to secure the spring, releasing the top bar and removing the trap from the device.

### BRIEF DESCRIPTION OF THE DRAWINGS

FIG. 1 is a depiction of a fur-bearing animal trap in use.

FIG. 2 is a perspective view of an embodiment of the trap setting device.

FIG. 3 is a perspective view of an embodiment of the trap setting device.

FIG. 4 is a perspective view of an embodiment of the trap setting device in use on a trap.

FIG. 5 is a perspective view of a second embodiment of the trap setting device.

FIG. 6 is a perspective view of a third embodiment of the trap setting device.

### DETAILED DESCRIPTION

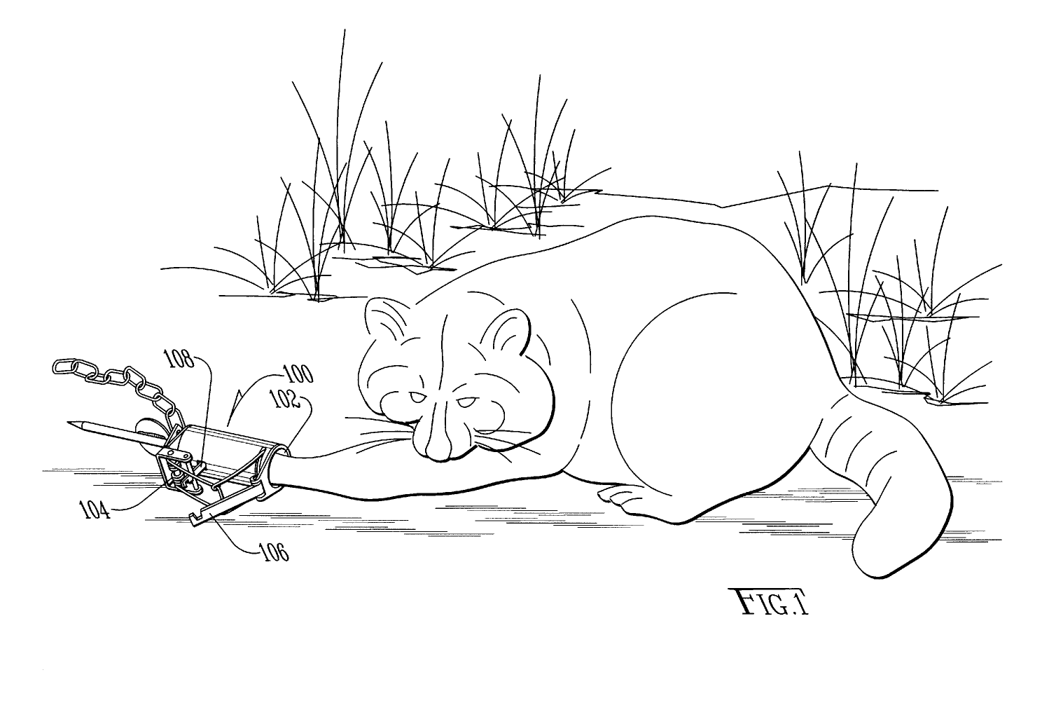

Referring now to FIG. 1, a depiction of a fur-bearing animal trap is depicted in use on an animal. The trap setting device is a hand held device for setting a trap 100 for a fur-bearing animal. In typical use of the trap 100 an animal inserts its paw into an opening 102 on the trap 100 that contains bait. The insertion of the paw into the trap releases a spring 104 that clamps the trap shut, firmly holding the animal's paw in the trap. The trap is set by compressing or twisting the spring 104 and locking it in place by connecting bar 106 to trigger 108. As described above, the process of manually setting the trap by compressing or twisting the spring 104 and simultaneously connecting bar 106 to trigger 108 can be difficult and unsafe.

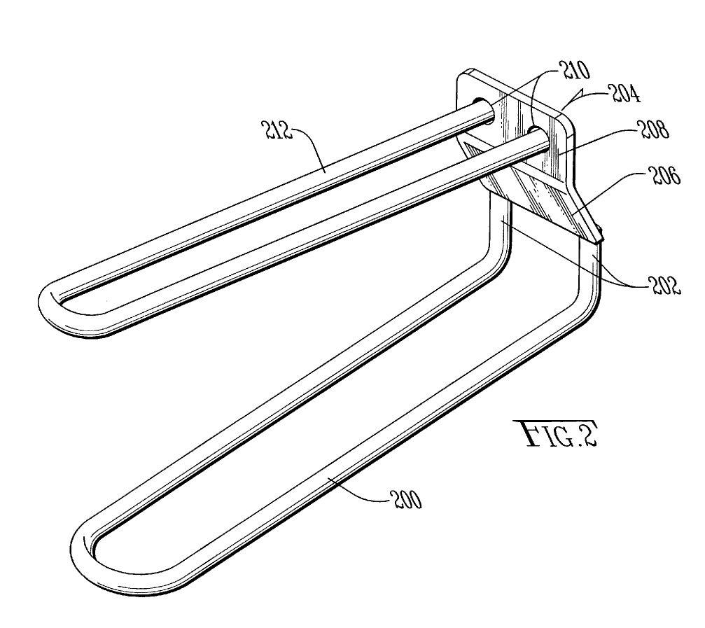

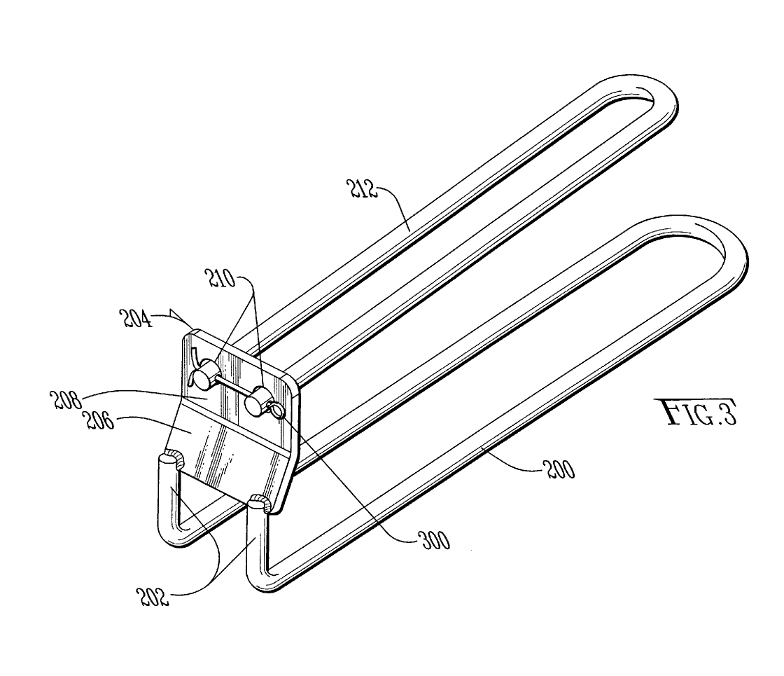

Referring now to FIGS. 2 and 3, perspective views of the trap setting device are depicted.

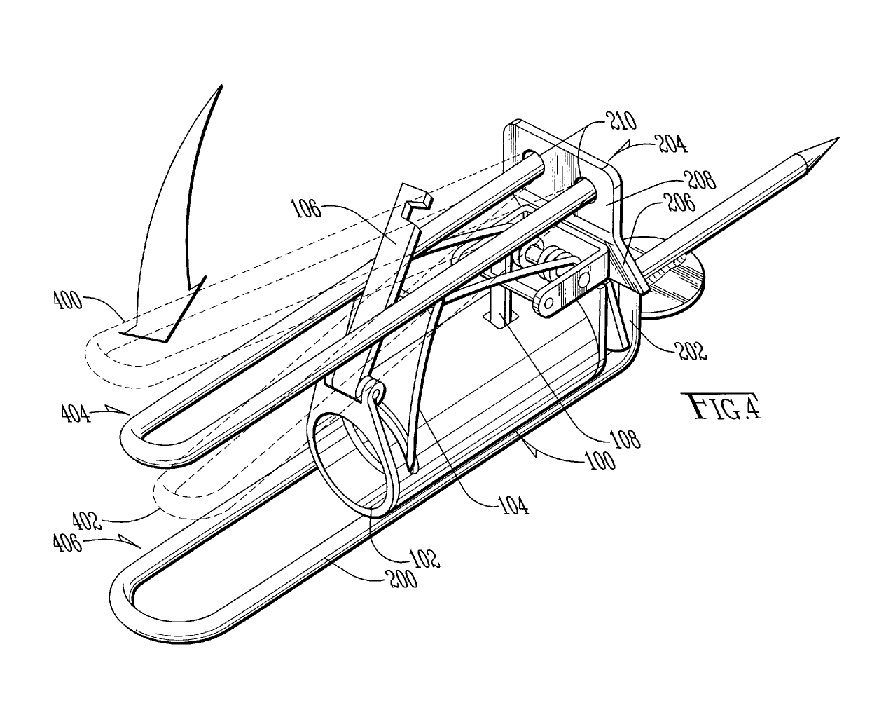

Base member 200 is provided for receiving and holding the trap 100 with a first end that is bent at a substantially right angle to the remainder of the base member 200. In a preferred embodiment the base member 200 comprises a metal bar that is bent into a U shape with upturned ends 202 to hold the trap. The upturned ends 202 create a space through which parts of the trap may be inserted during use of the device as shown in FIG. 4. In other embodiments of the trap setting device the base member 200 may be a sheet or plate of material which may be cut or bent to shape, and may have a central opening or a groove to hold the trap 100 in place.

Connector plate 204 is attached to the upturned ends 202 of base member 200. The connector plate supplies the leverage to apply pressure to the trap spring 104 for a successful trap set. In some embodiments, the connector plate 204 comprises a lower angled portion 206 attached to the base member 200, and an upper portion 208 for pivotally holding a top bar 212. In some embodiments the connector plate will be flexible to provide additional leverage to the user of the device. In a preferred embodiment the connector plate 204 is attached to the base member 200 by welding.

In the depicted embodiment, top bar 212 is formed from a metal bar bent into a U shape with two ends of the bar disposed substantially parallel to and slightly separated from each other. In other embodiments of the trap setting device the top bar 212 may be formed from a sheet or plate of material cut with holes as necessary for the operation of the device.

The top bar 212 compresses the spring 104 and allows the user to set and manipulate the bar 106 and trigger 108 of the trap 100 while holding the spring in a compressed position. The first end of top bar 212 is pivotally attached to the upper portion of the connector plate. In the depicted embodiment, the pivotal attachment comprises holes 210 which have a diameter or size sufficiently larger than the metal bar used to form top bar 212 to allow the top bar 212 to pivot up and down. In other embodiments of the trap setting device a hinge or other type of pivotal connection may be utilized in place of the holes 210.

In the depicted embodiment one or more pins or wire 300 is used to secure the top bar 212 in the holes 210. The holes 210 may be spaced apart as necessary to allow top bar 212 to have the necessary clearance for the trap. The pins 300 are inserted through one or more holes in the end of top bar 212 and spread or twisted to prevent slippage. In other embodiments the top bar 212 may be welded to a hinge attached to connector plate 204 or otherwise secured to the upper portion 208 of the connector plate 204. In some embodiments of the device, multiple sets of holes 210 may be provided to allow for the adjustment of the top bar 212 for various sizes and types of traps. The multiple sets of holes may be disposed to allow the top bar 212 to be moved closer to or farther away from base 200, or to allow various widths of top bar 212 to be used with the device. In some embodiments the sets of holes are spaced closer to and farther away from the base member 200 to allow for adjustment of the size of the trap.

In a preferred embodiment of the trap setting device, top bar 212 is formed by cutting a metal bar ( 3/16″ or ¼″ metal rod) to 21 inches long. The metal bar is bent in the middle to create a ¾ “loop (90 degree), resulting in 10 inch long metal bar 212, which is now 2 bars with ¾” opening between them. One hole is drilled through both ends of the top bar rod. The 2 metal rod loose ends are inserted into the 2 holes in the connector plate 204 and secured by pins 300 through the holes in the top bar rod ends. Similarly in a preferred embodiment base member 200 is formed by cutting a metal bar ( 3/16″ or ¼″ metal rods) to 25 inches long. The metal bar is bent in middle to create a ¾″ loop (90 degrees), resulting in a 14 inch long metal bar 200. Then 2 inches on each loose end 202 of the metal rod is bent 90 degrees upwardly. These ends are welded onto the connector plate 204. A preferred embodiment of the connector plate 204 is solid metal 2⅝″ long by 1½″ wide with two holes 210 drilled in the upper portion 208, ¾″ a part. A hinge or spring can be used instead of metal connector plate 204. The size of the parts may be changed to fit varying types and sizes of traps. Metals used for the device include angle iron, steel bars and other metal types.

In one embodiment, base member 200 is a length of angle iron disposed lengthwise with the two edges thereof disposed upwardly and the corner thereof disposed downwardly forming a groove to hold the trap. A first end of the angle iron is attached to the connector plate 204 by welding the upwardly turned edges to the plate 204 with the length of the angle iron extending substantially perpendicular to the connector plate 204 to form base 200.

Referring now to FIG. 4, a perspective view of the trap setting device in use on a trap is depicted. In order to use the trap setting device, top bar 212 is opened to position 400. Then a trap 100 is inserted into the trap setting device and rests on base member 200 and against connector plate 204, with the spring 104 and trigger assembly components 106 and 108 disposed toward top member 212. In the depicted embodiment, the trigger assembly components 106 and 108 are disposed between the arms of the U shaped top bar 212, though in other embodiments for other traps 100 this may be different. The user then exerts pressure on the trap setting device to by squeezing second end 404 of top bar 212 toward second end 406 of base member 200 until top bar 212 is in position 402. This movement of top bar 212 brings it in contact with the spring 104 of the trap 100, and compresses or twists the spring 104 as necessary to arm the trap 100. Due to the leverage provided by the top bar 212 and connector plate 204 the user can hold the spring in a compressed position easily. The user can then quickly and safely set the trap by engaging the trigger mechanism, shown in this embodiment as bar 106 and trigger 108, while keeping his fingers and hand away from the spring mechanism. The user then releases the pressure on top bar 212 and base member 200, and removes the trap 100 from the trap setting device. The trap 100 is then ready to be placed for use trapping an animal.

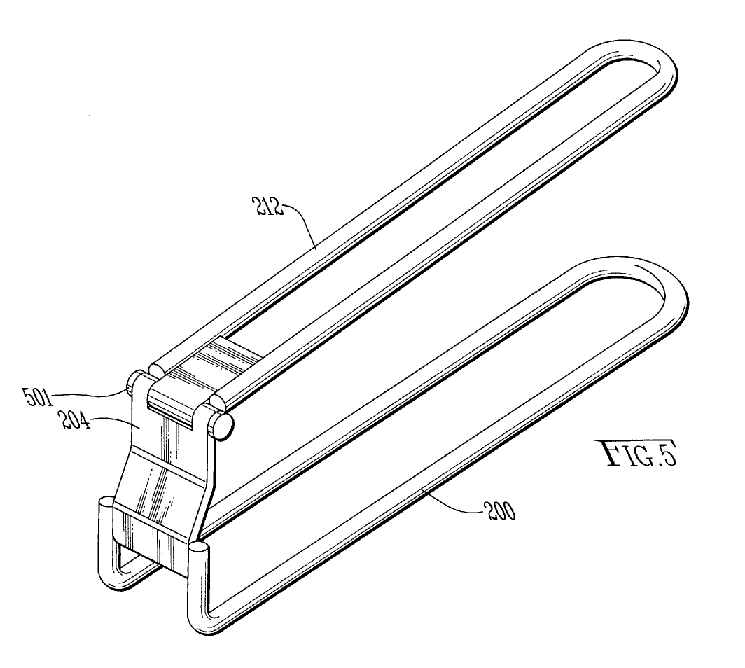

Referring now to FIG. 5, a perspective view of a second embodiment of the trap setting device is depicted. In this alternative embodiment, a hinge 501 is incorporated into or attached to connector plate 204 and to top bar 212. This allows the top bar to be pivoted as necessary to compress the spring and set the trap.

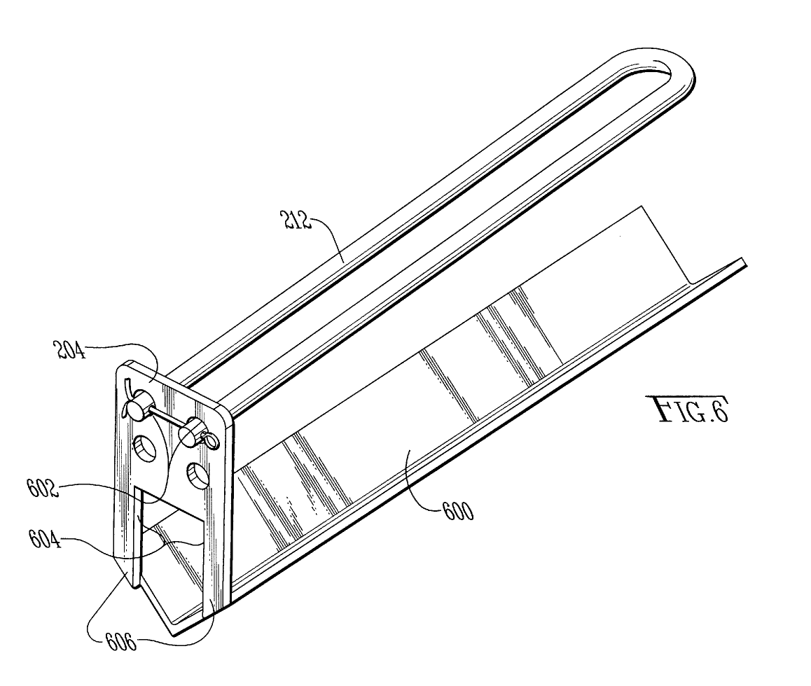

Referring now to FIG. 6, a perspective view of a third embodiment of the trap setting device is depicted. In this alternative embodiment, an additional set of holes 602 is provided for receiving top bar 212. This allows the device to be adjusted for use with varying sizes of traps. Also in this depicted embodiment, the base member 200 comprises angle iron 600. The angle iron 600 is attached to connector plate 204 by extensions 606, which may be formed as part of connector plate 204 or separate therefrom. The extensions 606 provide hole 604 which provides clearance for the trap to be inserted into the device.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention, and may utilize other materials than those described where appropriate.

It will be understood that certain features and subcombinations are of utility and may be employed without reference to other features and subcombinations and are contemplated within the scope of the claims. Not all steps listed in the various figures need be carried out in the specific order described.

What is claimed is:

1. A device for setting a trap comprising:
a base member for receiving and holding a trap;
a top bar; and
a connector plate having an upper portion and a lower portion;
wherein the first end of the base member is fixedly attached to the lower portion of the connector plate; and
wherein a first end of the top bar is pivotally attached to the upper portion of the connector plate such that a second end of the top bar pivots toward a second end of the base member.

2. The device of claim 1 wherein the top bar comprises a metal bar bent so that the ends of the bar are disposed substantially parallel to and separated from each other.

3. The device of claim 2 wherein the upper portion of the connector plate is provided with a set of holes for receiving the ends of the metal bar; wherein the holes are slightly larger than the metal bar to allow it to pivot within the holes.

4. The device of claim 3 wherein the upper connector plate is provided with a plurality of sets of holes for receiving the ends of the metal bar.

5. The device of claim 4 wherein the plurality of sets of holes are spaced apart to allow the device to be adjusted for the size of the trap.

6. The device of claim 2 wherein the ends of the metal bar are attached to the upper connector plate by a hinge.

7. The device of claim 2 wherein the base member comprises a metal bar bent so that the ends of the bar are substantially parallel to and separated from each other, wherein the base member has a first end that is bent at a right angle to the remainder of the base member.

8. The device of claim 2 wherein the base member comprises a section of angle iron disposed with the corner thereof away from the connector plate.

9. The device of claim 2 wherein the lower portion of the connector plate is disposed at an angle to the upper portion of the connector plate.

10. A method for using the device of claim 1 with a trap having a spring and a trigger assembly comprising the steps of:
pivoting the top bar to an open position;
placing a trap on the base member with the spring disposed away from the base member;
pivoting the top bar to a closed position to twist the spring;
engaging the trigger assembly to secure the spring;
releasing the top bar; and
removing the trap from the device.
